(19) United States
(12) Patent Application Publication
(10) Pub. No.: US 2026/0222939 A1
(43) Pub. Date: Jul. 30, 2026

(54) METHODS AND APPARATUS FOR PERFORMING LOWER LAYER TRIGGERED MOBILITY IN A WIRELESS COMMUNICATION SYSTEM

(71) Applicant: SAMSUNG ELECTRONICS CO., LTD., Suwon-si, Gyeonggi-do (KR)

(72) Inventor: Aby Kanneath ABRAHAM, Bangalore (IN)

(21) Appl. No.: 19/145,864

(22) PCT Filed: Jan. 3, 2024
(86) PCT No.: PCT/KR2024/000128

§ 371 Date: Jul. 3, 2025

(30) Foreign Application Priority Data
Jan. 3, 2023 (IN) 202341000377
Dec. 19, 2023 (IN) 202341000377

(51) Int. Cl. H04W 36/04; H04W 28/02; H04W 76/20

(52) U.S. Cl. CPC H04W 36/04; H04W 28/0273; H04W 76/20

(57) ABSTRACT

The disclosure relates to a 5G or 6G communication system for supporting a higher data transmission rate. Embodiments herein disclose methods and systems for performing lower layer triggered mobility in NR. Embodiments herein disclose methods and systems for enabling the gNB to communicate the reference configuration to a UE, wherein the received reference configuration can be used for the LTM to the UE. Embodiments herein disclose methods and systems for enabling the gNB to communicate to the UE to apply full configuration for LTM during LTM. Embodiments herein disclose actions to be performed by the UE for full configuration for LTM. Embodiments herein disclose actions to be performed by the UE for addition/modification/release of LTM reference configuration. Embodiments herein disclose methods and systems for performing internode communication between gNB and DU for LTM.

### TECHNICAL FIELD

Embodiments disclosed herein relate to wireless communication networks, and more particularly to handling Lower layers (L1/L2 layers) Triggered Mobility (LTM) in wireless communication networks.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIOT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

In wireless technologies like 5G NR, devices can move across different cells. Mobility can be performed using a procedure called cell reselection in RRC_IDLE mode. Till NR R17, mobility can be performed using a procedure called handover in RRC_CONNECTED mode. Network controlled mobility applies to User Equipments (UEs) in RRC_CONNECTED. It requires explicit Radio Resource Control (RRC) signalling to be triggered by the gNodeB (gNB) in New Radio (NR). Handover in NR comprises of three steps: handover preparation, handover execution and handover completion. The gNB may configure the UE to report measurements and based on the reported measurements or based on its own understanding of the network topology, the gNB will send a RRC Reconfiguration message to handover the UE to another cell (hereinafter referred to herein as a target cell) from the source cell. The UE accesses the target cell and sends a RRC Reconfiguration complete message.

In an alternative way introduced in 3GPP NR release 16, the gNB may configure the UE with one or more execution conditions for triggering handover and once the execution conditions are satisfied, the UE may move to the target cell and send the RRC Reconfiguration complete. In all these methods, the UE performs handover by sending layer 3 (RRC) messages which causes considerable signalling overhead and latency issues. During handover, the UE may be configured to apply full configuration for LTM, during a L3 handover, and if configured, the UE applies full configuration for LTM as described in section 5.3.5.11 of TS 38.331

For the purpose herein, 3GPP specifications such as TS38.300, TS38.331, TS 38.321 V17.2.0 can also be considered as a relevant background.

3GPP release 18 is considering using Lower layers (L1/L2 layers) Triggered Mobility (LTM) for performing handover. As per 3GPP, the goal of LTM is to enable a serving cell change via L1/L2 signalling, in order to reduce the latency, overhead and interruption time. The network (gNB) may configure the UE with multiple candidate cells to allow fast application of configurations for candidate cells. The network may further send MAC CE or L1 signalling to dynamically switch the UE from a source cell to one of the configured candidate cells. Further, the LTM can be triggered based on L1 measurements rather than L3 measurements.

3GPP proposes to perform LTM, without resetting the lower layers (like MAC) to avoid data loss and to reduce the additional delay of data recovery wherever it is possible. The gNB may provide LTMCandidateConfiguration; i.e., configure LTM candidate cells through one RRCReconfiguration message for a candidate target cell or through one CellGroupConfig for each candidate target cell or through any similar RRC structure or IE containing the similar fields. For example, a new IE LTMCandidateConfig can be defined as ASN.1 sequence containing cellgroupconfig and some other information elements in the RRCReconfiguration. The gNB may further release or modify the candidate configurations. A UE may store the LTM configuration of other candidate cells even after moving to a candidate cell through LTM.

To avoid transmitting a large message over air interface, the gNB can provide the LTMCandidateConfiguration as delta configuration instead of full configuration for LTM. The gNB can indicate to the UE to use the source cell configuration as the reference for delta configuration or provide the reference configuration explicitly.

Currently, there is no solution defined for how the gNB communicates (i.e., how does the UE know) the reference configuration to be used for the LTM to the UE.

Currently, there is no solution defined for how the gNB communicates (i.e., how does the UE know) that the UE need to apply full configuration during LTM.

Currently, there are no actions defined to be taken by the UE for performing full configuration for LTM.

Currently, there are no actions defined to be taken by the UE for performing addition/modification/release of the LTM reference configuration.

Currently, there is no method defined for performing internode communication between gNB CU and DU for LTM.

Hence, there is a need in the art for solutions which will overcome the above mentioned drawback(s), among others.

The principal object of the embodiments herein is to disclose methods and systems for performing Lower-layer Triggered Mobility (LTM) in New Radio (NR).

Another object of the embodiments herein is to disclose methods and systems for enabling the gNB to communicate the reference configuration to a UE, wherein the received reference configuration can be used for the LTM to the UE.

Another object of the embodiments herein is to disclose methods and systems for enabling the gNB to communicate to the UE to apply full configuration during LTM.

Another object of the embodiments herein is to disclose actions to be performed by the UE for full configuration for LTM.

Another object of the embodiments herein is to disclose actions to be performed by the UE for addition/modification/release of LTM reference configuration.

Another object of the embodiments herein is to disclose methods and systems for performing internode communication between gNB and DU for LTM.

### DISCLOSURE OF INVENTION

### Solution to Problem

Accordingly, the embodiments herein provide a method for performing Lower-layer Triggered Mobility (LTM) in New Radio (NR). A User Equipment (UE) receives at least one of a flag indicating to apply complete configuration for LTM in LTM candidate cell configuration and LTM reference configuration in Radio Resource Control (RRC) signalling from a gNodeB (gNB). If the flag has been received, on LTM trigger, the UE performs a full configuration for LTM by applying the received LTM candidate cell configuration. If the flag has not been received, on LTM trigger, the UE applies the LTM candidate cell configuration as a delta configuration of the reference configuration.

Accordingly, the embodiments herein provide a User Equipment (UE) comprising a processor; a memory; and a Lower-layer Triggered Mobility (LTM) controller, coupled with the processor and the memory. The LTM controller can be configured to receive at least one of a flag indicating to apply complete configuration for LTM in LTM candidate cell configuration and LTM reference configuration in Radio Resource Control (RRC) signalling from a gNodeB (gNB). The LTM controller can be configured to perform a full configuration for LTM by applying the received LTM candidate cell configuration, if the flag has been received, on LTM trigger. The LTM controller can be configured to apply the LTM candidate cell configuration as a delta configuration of the reference configuration, if the flag has not been received, on LTM trigger.

Accordingly, the embodiments herein provide a gNodeB (gNB) Distributed Unit (DU) configured to receive LTM configuration from a gNB Centralized Unit (CU), wherein the LTM configuration includes at least one of LTM reference configuration, LTM candidate cell configuration and LTM measurement configuration. The gNB DU can be further configured to generate a full Lower-layer Triggered Mobility (LTM) configuration (if the gNB CU has not provided the LTM reference configuration to the gNB DU). The gNB DU can be further configured to generate a delta configuration based on a part of a LTM reference configuration, wherein the part of the received LTM reference configuration is received from the gNB CU. The gNB DU can further provide at least one of the full configuration for LTM, and the delta configuration for LTM to the gNB CU.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 depicts a Fifth Generation (5G) network, according to embodiments as disclosed herein; and

FIG. 2 depicts the process of performing Reference configuration/full configuration in Lower Layer Triggered Mobility (LTM), according to embodiments as disclosed herein.

FIG. 3A is a flowchart depicting the process of performing Lower-layer Triggered Mobility (LTM) in New Radio (NR), according to embodiments as disclosed herein;

FIG. 3B is a flowchart depicting the process of performing a full configuration, according to embodiments as disclosed herein;

FIG. 4 depicts a UE configured to perform Lower-layer Triggered Mobility (LTM) in New Radio (NR), according to embodiments as disclosed herein;

FIG. 5 depicts a wireless communication network comprising a source gNB, and a target gNB, according to embodiments as disclosed herein;

FIG. 6 depicts an example process of performing CU-DU interaction for Lower Layer Triggered Mobility (LTM), according to embodiments as disclosed herein;

FIG. 7 is a flowchart depicting the process of handling a configuration in New Radio (NR), according to embodiments as disclosed herein; and

FIG. 8 depicts a gNB DU (which can be either the source gNB DU 501B, or the target gNB DU 502B) configured to handle a configuration in New Radio (NR), according to embodiments as disclosed herein.

FIG. 9 illustrates a UE according to embodiments as disclosed herein.

FIG. 10 illustrates a base station according to embodiments as disclosed herein.

### BEST MODE FOR CARRYING OUT THE INVENTION

Aspects of the disclosure are to address at least the above-mentioned problems and/or disadvantages and to provide at least the advantages described below. Accordingly, an aspect of the disclosure is to provide a terminal and a communication method thereof in a wireless communication system.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

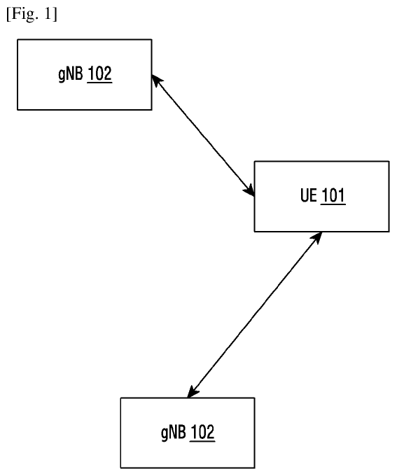

The embodiments herein achieve methods and systems for performing Lower-layer Triggered Mobility (LTM) in New Radio (NR). Referring now to the drawings, and more particularly to FIGS. 1 through 8, where similar reference characters denote corresponding features consistently throughout the figures, there are shown embodiments.

Embodiments herein disclose a UE receiving LTM reference configuration in LTM candidate cell configuration in RRC signalling from a gNB and applies the same. According to embodiments as disclosed herein, the UE can receive a flag indicating whether to apply complete configuration for LTM in RRC signalling from the gNB and upon LTM trigger (if the flag has been received), the UE can perform full configuration for LTM. In various embodiments herein, the UE can keep security configuration, C-RNTI during full configuration for LTM. In various embodiments herein, the UE can also keep the received LTM configuration during full configuration for LTM.

Embodiments herein also address internode signalling between the gNB CU (centralized unit) and the gNB DU (distributed unit) for handling reference configuration(s).

FIG. 1 depicts a Fifth Generation (5G) network. The 5G network 100, as depicted, comprises one or more UEs 101 and one or more gNBs 102. The gNB 102 can configure the UE 101 with a reference configuration (here after referred as LTMRefConfig), wherein the UE 101 can use the LTMRefConfig for LTM. In various embodiments herein, the gNB 102 provides the LTMRefConfig to the UE 101 as an octet string containing RRCReconfiguration SEQUENCE, as defined in TS 38.331 NR specification.

In various embodiments herein, the gNB 102 can provide the LTMRefConfig as an octet string, wherein the octet string contains LTM candidate configuration message. For example, the LTM candidate configuration message can be a RRC ASN.1 SEQUENCE and can contain one of CellGroupConfig, RRCReconfiguration or a separate RRC SEQUENCE. The RRC ASN.1 SEQUENCE can contain RRC IEs, such as, but not limited to, CellGroupConfig, measurement configuration, radio bearer configuration, and so on.

In various embodiments herein, the gNB 102 can configure the UE 101 with LTMRefConfig as an ASN.1 SEQUENCE containing RRC IEs (such as, but not limited to, CellGroupConfig) and optionally, IEs (such as, but not limited to, measurement configuration, radio bearer configuration, and so on).

The gNB 102 can provide reference configuration, L1 measurement configuration and candidate cell configuration in a RRC ASN.1 SEQUENCE used for LTM Configuration.

An example RRC ASN.1 SEQUENCE used for LTM Configuration is given as below:

```
RRCReconfiguration-v18xx-Ies ::= SEQUENCE {
        candLTM-Reconfiguration SEQUENCE CandLTM Reconfiguration
      OPTIONAL -Need M,
LTMMeasConfig LTMMeasConfig OPTIONAL -Need M,
          nonCriticalExtension RRCReconfiguration-v1xxx-Ies
                          OPTIONAL,
      LTMRefConfig LTMRefConfigType OPTIONAL -Need M,
      }
CandLTM-Reconfiguration ::= SEQUENCE {
        candLTM-ReconfigToRemoveList CandLTM-ReconfigToRemoveList
      OPTIONAL, -- Need N
        candLTM-ReconfigToAddModList CandLTM-ReconfigToAddModList
      OPTIONAL, -- Need N
        ...
      }
CandLTM-ToAddModList ::= SEQUENCE (SIZE (1..maxNr)) OF CandLTM-ToAddMod
CandLTM-ToAddMod ::=  SEQUENCE {
        candLTM-ReconfigId CandLTM-ReconfigId,
        candLTM-Reconfig OCTET STRING (CONTAINING RRCReconfiguration) ,
      }
```

In various embodiments herein, the reference configuration can be an OCTETSTRING containing RRCReconfiguration. An example is given below with reference to TS 38.331 V17.2.0.

LTMRefConfigType OCTET STRING (CONTAINING RRCReconfiguration)

Alternatively, candidate LTM configuration may be provided as an ASN.1 SEQUENCE to the UE 101 by the gNB 102 in an example as given below:

```
CandLTM-ToAddMod ::=  SEQUENCE {
        candLTM-ReconfigId CandLTM-ReconfigId,
        candLTM-Reconfig CandLTM-Reconfig,
      }
      CandLTM-Reconfig ::=  SEQUENCE {
      candLTM-CellGroupConfig CellGroupConfig,
      measConfig MeasConfig OPTIONAL,
      radioBearerConfig RadioBearerConfig OPTIONAL,
      <other IEs>
      }
```

In various embodiments herein, the gNB 102 can provide the LTMRefConfig (as an ASN.1 SEQUENCE to the UE, wherein the ASN.1 SEQUENCE includes CellGroupConfig), and optionally, other IEs such as MeasConfig, RadioBearerConfig, and so on. An example is given below with reference to TS 38.331 V17.2.0.

LTMRefConfig-Type ::= SEQUENCE {
candLTM-CellGroupConfig CellGroupConfig,
measConfig MeasConfig OPTIONAL,
radioBearerConfig RadioBearerConfig OPTIONAL,
<other IEs>
}

In various embodiments herein, the LTMRefConfig can be received as an OCTET STRING. In various embodiments herein, the OCTETSTRING can contain CandLTMReconfig. In another embodiment herein, the OCTET STRING can contain CellGroupConfig.

When the LTMREFConfig is provided, the LTM candidate cell configuration can be a delta configuration with reference to the LTMRefConfig. The UE 101 can store the reference configuration as a separate configuration, wherein the UE 101 can manage the reference configuration separately.

In various embodiments herein, the UE 101 can be configured with multiple reference LTM configurations, wherein the reference LTM configurations can include a reference configuration identifier. Each candidate LTMConfiguration can be associated with a reference configuration identifier.

```
LTM-Refconfiguration ::= SEQUENCE {
  LTM-RefconfigToRemoveList LTM-RefconfigToRemoveList OPTIONAL, -- Need N
//Release reference configuration.
  LTM-RefconfigToAddModList LTM-RefconfigToAddModList OPTIONAL, -- Need
N //Add or modify reference configuration.
  ...
}
LTMRefConfig-ToAddModList ::= SEQUENCE (SIZE (1..maxNr)) OF LTMRefConfig-
ToAddMod
LTMRefConfig-ToAddMod ::= SEQUENCE {
        LTM-RefconfigId LTM-RefconfigId,
        candLTM-Refconfig RefConfigType ,
      }
```

The UE 101 can receive multiple reference configurations (for example, as a list of reference configurations) from the gNB 102. The UE 101 can also receive reference configuration identifier for individual candidate LTM cell configurations. The UE 101 can further apply the reference configuration corresponding to the received reference configuration identifier.

The gNb 102 can inform the UE 101 to add, modify or release the reference configuration through the RRC Reconfiguration. In various embodiments herein, the UE 101 can release all the stored LTM candidate cell configurations, one the reference configuration (used by the candidate cell configurations) being released. If the UE 101 is configured with multiple reference configurations, the UE 101 can release all the stored LTM candidate cell configurations associated with the released reference configuration(s), when only a subset of reference configurations are released. For example, the UE 101 may be configured with two reference configurations; RefConf1,RefConf2 and two candidate cell configurations (CandidateConf1, CandidateConf2). CandidateConf1 can be associated with RefConf1, and CandidateConf2 can be associated with RefConf2). If the gNB 102 informs the UE 101 to release RefConf1, according to this embodiment, the UE 101 can release CandidateConf1 and keeps CandidateConf2.

In various embodiments herein, a reference configuration is provided using a parameterized type SetupRelease as defined in TS 38.331 by the gNB to the UE.

### SetupRelease

SetupRelease allows the ElementTypeParam to be used as the referenced data type for the setup and release entries. See A.3.8 for guidelines.

```
-- ASN1START
-- TAG-SETUPRELEASE-START
SetupRelease { ElementTypeParam } ::= CHOICE {
        release NULL,
        setup ElementTypeParam
}
-- TAG-SETUPRELEASE-STOP
-- ASN1STOP
```

Setup can be used by the UE 101 to add a reference configuration or modify a reference configuration, while Release can be used by the UE 101 to release an already configured reference configuration.

An example sequence of the reference configuration is given as below:

```
RRCReconfiguration-v18xx-Ies ::=  SEQUENCE {
      candLTM-Reconfiguration SEQUENCE CandLTM-Reconfiguration
      OPTIONAL -Need M,
LTMMeasConfig LTMMeasConfig OPTIONAL -Need M,
    nonCriticalExtension RRCReconfiguration-v1xxx-Ies
                    OPTIONAL,
LTMRefConfig SetupRelease { LTMRefConfigType } OPTIONAL -Need M,
}
```

In various embodiments herein, the UE 101 can receive an indication from the gNB 102, wherein the indication can indicate whether to use the current cell LTM configuration or any candidate cell LTM configuration as the reference configuration, or the received LTM reference configuration.

On the UE 101 receiving an indication to use the current cell LTM configuration, the UE 101 can discard the previously received reference configuration, if any.

In various embodiments herein, the UE 101 may receive a choice RRC ASN.1 structure as below. The choice structure may also be designed with a part of the IEs in the below example structure.

LTM-RefConfig CHOICE {
LTMRefConfig LTMRefConfigType,
LTMRefConfig SetupRelease { LTMRefConfigType },
useCurrentCell ENUMERATED {true}, //UE uses the IEs related to the current cell as the
reference configuration,
LTMRefCandidate CandLTM-ReconfigId, //UE uses LTM configuration as identified by the
RefCandidate as the reference configuration. Alternatively, the UE may receive the PCI, and UE
applies the LTM configuration corresponding to the PCI as reference configuration.
}

In various embodiments herein, the UE 101 can generate a complete LTM configuration (full LTM configuration) by applying the delta configuration over reference configuration and on LTM trigger, the UE 101 can apply the procedure for full configuration for LTM, as described in embodiments herein.

In various embodiments herein, if the gNB 102 does not provide a reference configuration, the UE 101 can use the current cell's configuration as the reference configuration.

In various embodiments herein, the UE 101 does not maintain or store the LTM reference configuration, and the LTM reference configuration can be provided as a Need N variable.

Embodiments herein have been explained using 5G and associated modules (gNB, NR, UE, CU, and DU); however, it may be obvious to a person of ordinary skill in the art that embodiments herein can be extended to any network/technology (6G, and so on) and associated components (i.e., gNB can be any network node, the CU can be any network node that has RRC functionality, DU can be any network node that has L2 functionality or L1 functionality, and the UE can be of any technology/network).

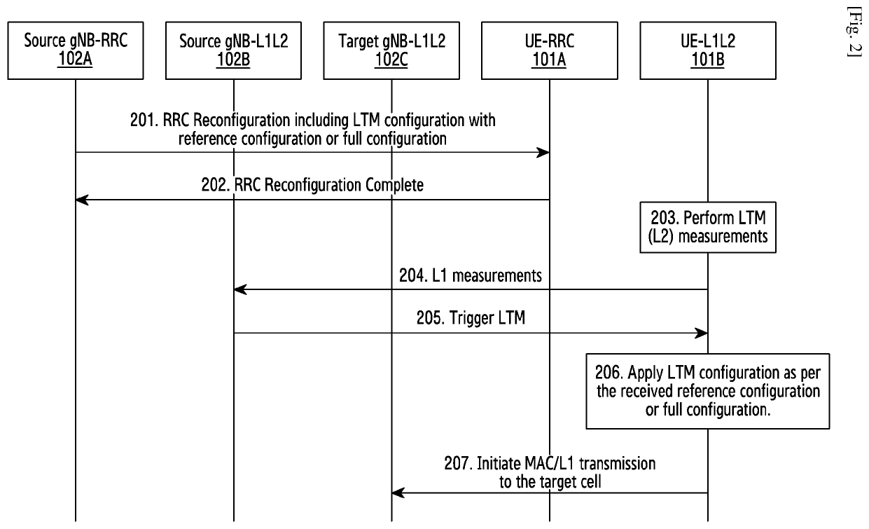

FIG. 2 depicts the process of performing Reference configuration/full configuration in Lower Layer Triggered Mobility (LTM). In various embodiments herein, the gNB 102 can provide an IE, (for example, a flag fullconfig) to indicate that the LTM candidate cell configuration is a full configuration and not a delta configuration. If the fullconfig is provided, the UE 101 can apply the full configuration for LTM without considering the configured reference configuration.

In various embodiments herein, the gNB 102 can use the existing RRC IE fullconfig for indicating that a fullconfig has to be applied for the LTM candidate cell configuration. In various embodiments herein, a new RRC IE may be defined, wherein the gNB 102 can use the new RRC IE for indicating that a fullconfig has to be applied. In various embodiments herein, the existing RRC IE fullConfig (as in NR TS 38.331) may be used for indicating that a generic full configuration for LTM (such as the fullconfiguration used for Layer3 handover or RRC Resume, i.e. not full config for LTM) has to be applied for the LTM candidate cell configuration as defined in RRC specifications. In various embodiments herein, the UE 101 may be configured with the new IE for full configuration for LTM and the existing IE for generic full configuration.

In various embodiments herein, the UE 101 can release all the LTM candidate cell configurations (i.e., delta configurations), on the reference configuration being released. The UE 101 can keep LTM candidate cell configurations (which are full configurations), on releasing the reference configuration. In various embodiments herein, the UE 101 can release any complete configuration generated by applying the candidate configuration on top of reference configuration, upon the reference configuration release.

In various embodiments herein, while performing fullconfiguration for LTM, the UE 101 can clear the current dedicated LTM configuration (or a part of the LTM configuration). When clearing the current dedicated LTM configuration (or a part of the LTM configuration), the UE 101 can exclude one or more of the following:
the logged measurement configuration;
the MCG C-RNTI;
the AS security configurations associated with the master key (and to the secondary key); and
the SRB1/SRB2 configurations and DRB/multicast MRB configurations as configured by radioBearerConfig or radioBearerConfig2. The current dedicated LTM configuration as referred to herein is the current dedicated configuration of the source cell.

In various embodiments herein, while performing full configuration for LTM, the UE 101 can apply the default L1 parameter values and apply the default MAC Cell Group configuration (as specified in TS 38.331 section 9.2.2). The default L1 parameter values can be the values as specified in corresponding physical layer specifications, except parameters for which values are provided in SIB1. The UE 101 can also release or clear all current common radio configurations and use the default values for timers T310, T311 and constants N310, N311 (as specified in TS 38.331 section 9.2.3).

In various embodiments herein, while performing full configuration for LTM, the UE 101 can apply the full configuration for LTM only for the IEs configured by the gNB 102. In various embodiments herein, a gNB Distributed Unit (DU) 102A can configure the IEs. In various embodiments herein, while performing full configuration for LTM, the UE 101 can apply full configuration for LTM for dedicated configuration related to layer1 and layer2 RLC and layer2 MAC. While performing full configuration for LTM, the UE 101 can clear the L1, and L2 RLC/MAC configuration as indicated in CellGroupConfig. In various embodiments herein, while performing full configuration for LTM, the UE 101 can clear the configuration configured by CellGroupConfig and keep all other dedicated configuration.

In various embodiments herein, while performing full configuration for LTM, the UE 101 can skip applying the default SRB configuration for the SRB1 and SRB2. In various embodiments herein, while performing full configuration for LTM, the UE 101 can skip applying the default SRB configuration. In various embodiments herein, while performing full configuration for LTM, the UE 101 can skip releasing SDAP entity (for example, as specified in clause 5.1.2 in TS 37.324). In various embodiments herein, while performing full configuration for LTM, the UE 101 can skip applying the default SRB configuration for releasing DRB associate to the PDU session (for example, as specified in TS 38.331 5.3.5.6.4). In various embodiments herein, the UE 101 can skip clearing the measurement configuration while performing the full configuration for LTM.

In various embodiments, while performing the generic full configuration, the UE 101 can release the SDAP entity and any variables or information within the SDAP entity. In various embodiments, if both generic full configuration and full configuration for LTM are configured, the UE 101 can release the SDAP entity and any variables or information within the SDAP entity.

In various embodiments herein, while performing the full configuration for LTM, UE 101 can keep (i.e., doesn't release/clear) one or more of the following configurations:
1. LTM measurement configuration (L1 measurement configurations for LTM)
2. LTM Reference configuration.
3. LTM candidate cell configuration (which may include all the stored LTM candidate cell configurations or only the current cell's LTM candidate cell configurations).

In various embodiments herein, while performing the generic full configuration, the UE 101 releases the LTM measurement configuration (L1 measurement configurations for LTM), the LTM reference configuration, the LTM candidate cell configuration or any other LTM configuration. In various embodiments, if both generic full configuration and full configuration for LTM are configured, the UE 101 releases the LTM measurement configuration (L1 measurement configurations for LTM), the LTM reference configuration, the LTM candidate cell configuration or any other LTM configuration.

In various embodiments herein, while performing full configuration for LTM, the UE 101 does not apply full configuration for MBS, PDU session or App layer measurement configurations.

In various embodiments herein, the UE 101 can perform full configuration for LTM during LTM by skipping all or some of the following steps performed during full configuration for RRCReconfiguration with sync (i.e. L3 handover), RRC Reestablishment or RRC Resume (also referred to herein as generic full configuration) with reference to TS 38.331 section 5.3.5.11 v17.2).
1> if the spCellConfig in the masterCellGroup includes the reconfiguration WithSync:
2> release/clear all current common radio configurations;
2> use the default values specified in 9.2.3 for timers T310, T311 and constants N310, N311;
1> else (full configuration after re-establishment or during RRC resume):
2> if the UE is acting as L2 U2N Remote UE:
3> use value for timer T311, as included in ue-TimersAndConstants received in SIB1
2> else:
3> use values for timers T301, T310, T311 and constants N310, N311, as included in ue-TimersAndConstants received in SIB1;
1> if no measConfigAppLayerId is included:
2> inform upper layers about the release of all application layer measurement configurations;
2> discard any received application layer measurement report from upper layers;
2> consider itself not to be configured to send application layer measurement report.
1> for each srb-Identity value included in the srb-ToAddModList (SRB reconfiguration):
2> establish an RLC entity for the corresponding SRB;
2> apply the default SRB configuration defined in 9.2.1 for the corresponding SRB;

NOTE 2: This is to get the SRBs (SRB1 and SRB2 for reconfiguration with sync and SRB2 for resume and reconfiguration after re-establishment) to a known state from which the reconfiguration message can do further configuration.
1> for each pdu-Session that is part of the current UE configuration:
2> release the SDAP entity (clause 5.1.2 in TS 37.324 [24]);
2> release each DRB associated to the pdu-Session as specified in 5.3.5.6.4;

NOTE 3: This will retain the pdu-Session, but remove the DRBs including drbidentity of these bearers from the current UE configuration. Setup of the DRBs within the Access Stratum (AS) is described in clause 5.3.5.6.5 using the new configuration. The pdu-Session acts as the anchor for associating the released and re-setup DRB. In the AS, the DRB re-setup is equivalent with a new DRB setup (including new PDCP and logical channel configurations).
1> for each mbs-SessionId that is part of the current UE configuration:
2> release the SDAP entity (clause 5.1.2 in TS 37.324 [24]);
2> release each multicast MRB associated to the mbs-SessionId as specified in 5.3.5.6.6;

NOTE 4: This will retain the mbs-SessionId but remove the multicast MRBs including mrb-identity of these bearers from the current UE configuration. Setup of the multicast MRBs within the AS is described in clause 5.3.5.6.7 using the new configuration. The mbs-SessionId acts as the anchor for associating the released and resetup multicast MRB. In the AS the multicast MRB re-setup is equivalent with a new multicast MRB setup (including new PDCP and logical channel configurations).
1> for each pdu-Session that is part of the current UE configuration but not added with same pdu-Session in the drb-ToAddModList:
2> if the procedure was triggered due to reconfiguration with sync:
3> indicate the release of the user plane resources for the pdu-Session to upper layers after successful reconfiguration with sync;
2> else:
3> indicate the release of the user plane resources for the pdu-Session to upper layers immediately;
1> for each mbs-SessionId that is part of the current UE configuration but not added with the same mbs-SessionId in the mrb-ToAddModList:
2> if the procedure was triggered due to reconfiguration with sync:
3> indicate the release of the user plane resources for the mbs-SessionId to upper layers after successful reconfiguration with sync;
2> else:
3> indicate the release of the user plane resources for the mbs-SessionId to upper layers immediately.

In various embodiments herein, while performing full configuration for LTM, the UE 101 can apply the default SRB configuration for the SRB1 and SRB2.

In various embodiments herein, while performing full configuration for LTM, the UE 101 can release the SDAP entity (clause 5.1.2 in TS 37.324).

In various embodiments herein, while performing full configuration for LTM, the UE 101 can release the DRB associated to the PDU session (for example, as specified in TS 38.331 of 5.3.5.6.4).

In various embodiments herein, while performing full configuration for LTM, the UE 101 can release the L3 measurement configuration (MeasConfig).

In various embodiments herein, while performing full configuration for LTM, the UE 101 can release the following configuration or some of the following configurations:
1. UE LTM measurement configuration (L1 measurement configurations for LTM)
2. LTM Reference configuration.
3. LTM candidate cell configurations (which may include all the stored LTM candidate cell configurations or may be only current cell's LTM candidate cell configurations).

In various embodiments herein, while performing for LTM, the UE 101 can apply for MBS, PDU session or App layer measurement configuration.

In various embodiments herein, the UE 101 can perform during LTM performing all or some of the following steps performed during RRCReconfiguration with sync, RRC Reestablishment or RRC Resume (with reference to TS 38.331 section 5.3.5.11 v17.2).
1> if the spCellConfig in the masterCellGroup includes the reconfiguration WithSync:
2> release/clear all current common radio configurations;
2> use the default values specified in 9.2.3 for timers T310, T311 and constants N310, N311;
1> else (after re-establishment or during RRC resume):
2> if the UE is acting as L2 U2N Remote UE:
3> use value for timer T311, as included in ue-TimersAndConstants received in SIB1
2> else:
3> use values for timers T301, T310, T311 and constants N310, N311, as included in ue-TimersAndConstants received in SIB1;
1> if no measConfigAppLayerId is included:
2> inform upper layers about the release of all application layer measurement configurations;
2> discard any received application layer measurement report from upper layers;
2> consider itself not to be configured to send application layer measurement report.
1> for each srb-Identity value included in the srb-ToAddModList (SRB reconfiguration):
2> establish an RLC entity for the corresponding SRB;
2> apply the default SRB configuration defined in 9.2.1 for the corresponding SRB; NOTE 2: This is to get the SRBs (SRB1 and SRB2 for reconfiguration with sync and SRB2 for resume and reconfiguration after re-establishment) to a known state from which the reconfiguration message can do further configuration.
1> for each pdu-Session that is part of the current UE configuration:
2> release the SDAP entity (clause 5.1.2 in TS 37.324 [24]);
2> release each DRB associated to the pdu-Session as specified in 5.3.5.6.4;

NOTE 3: This will retain the pdu-Session but remove the DRBs including drbidentity of these bearers from the current UE configuration. Setup of the DRBs within the AS is described in clause 5.3.5.6.5 using the new configuration. The pdu-Session acts as the anchor for associating the released and re-setup DRB. In the AS the DRB re-setup is equivalent with a new DRB setup (including new PDCP and logical channel configurations).
1> for each mbs-SessionId that is part of the current UE configuration:
2> release the SDAP entity (clause 5.1.2 in TS 37.324 [24]);
2> release each multicast MRB associated to the mbs-SessionId as specified in 5.3.5.6.6;

NOTE 4: This will retain the mbs-SessionId but remove the multicast MRBs including mrb-identity of these bearers from the current UE configuration. Setup of the multicast MRBs within the AS is described in clause 5.3.5.6.7 using the new configuration. The mbs-SessionId acts as the anchor for associating the released and resetup multicast MRB. In the AS the multicast MRB re-setup is equivalent with a new multicast MRB setup (including new PDCP and logical channel configurations).
1> for each pdu-Session that is part of the current UE configuration but not added with same pdu-Session in the drb-ToAddModList:
2> if the procedure was triggered due to reconfiguration with sync:
3> indicate the release of the user plane resources for the pdu-Session to upper layers after successful reconfiguration with sync;
2> else:
3> indicate the release of the user plane resources for the pdu-Session to upper layers immediately;
1> for each mbs-SessionId that is part of the current UE configuration but not added with the same mbs-SessionId in the mrb-ToAddModList:
2> if the procedure was triggered due to reconfiguration with sync:
3> indicate the release of the user plane resources for the mbs-SessionId to upper layers after successful reconfiguration with sync;
2> else:
3> indicate the release of the user plane resources for the mbs-SessionId to upper layers immediately.

In various embodiments herein, the UE 101 can receive an indication from the gNB 102, on the UE 101 needing to release LTM configurations other than CellGroupConfig during full configuration for LTM. The indication from the gNB 102 to the UE 101 may also indicate whether the UE 101 can perform some of the following operations: release DRB, apply SRB, release measurement configuration, release reference configuration, and release LTM Measurement configuration (configuration for L1 measurements for LTM).

In various embodiments herein, the UE 101 can release the LTM configuration other than CellGroupConfig based on the indication. The indication can be an optional indication which may be a flag. If the indication is not present, the UE can clear all the configurations in LTM configuration.

Alternatively, the default behavior can be such that if the indication is not present, the UE 101 does not clear all the LTM configuration. Alternative to the receiving indication to clear the LTM configuration, the UE 101 may receive an optional indication to keep all the configurations other than CellGroupConfig.

In step 201, a source gNB-RRC 102A shares the RRC Reconfiguration with UERRC 101A, wherein the shared RRC Reconfiguration includes the LTM configuration with either the reference configuration or the flag indicating to perform full configuration for LTM. In step 202, the UE-RRC 101A completes the RRC Reconfiguration (based on if the received LTM configuration comprises either the reference configuration, or the full configuration for LTM). In step 203, UE-L1L2 101B performs LTM (L1) measurements and in step 204, the UE-LIL2 101B communicates the measured L1 measurements to a source gNB-L1L2 102B. Based on the received measured L1 measurements, in step 205, the source gNB-L1L2 102B triggers LTM. In various embodiments herein, the LTM trigger can occur due to other actions than the reception of L1 or L2 message from the gNB 102; for example, upon radio link failure, if the UE 101 selects a cell (which is a LTM candidate cell), the UE 101 may behave as if LTM is triggered, i.e. perform actions upon LTM trigger, if the UE 101 has been configured by the network to do so. In step 206, the UE-L1L2 101B applies the RRC Reconfiguration (based on if the received LTM configuration comprises either the reference configuration, or the full configuration for LTM). In step 207, the UE-L1L2 101B initiates MAC/L1 transmission to the target gNB-L1L2 102C (i.e., the target cell). The UE 101 sends RRCRecconfigurationComplete to complete LTM within the same MAC/L1 transmission or in a next transmission.

The LTM configuration can include a flag in each LTM candidate configuration, and a LTM reference configuration in LTM configuration outside the LTM candidate configuration, (i.e., the reference configuration is applicable for all the LTM candidate configuration). If the flag is present in the LTM candidate configuration, the UE 101 can disregard the LTM reference configuration and apply the full configuration for LTM. If the flag is absent in the LTM candidate configuration, the UE 101 can generate a LTM configuration to be applied as a delta configuration on the top of LTM reference configuration. If all the LTM candidate configurations are full configurations, it is not mandatory to have LTM reference configuration. Irrespective of the presence/absence of LTM reference configuration, the flag may be included.

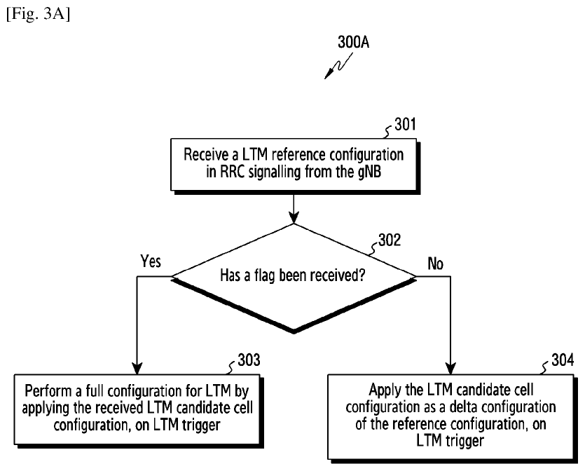

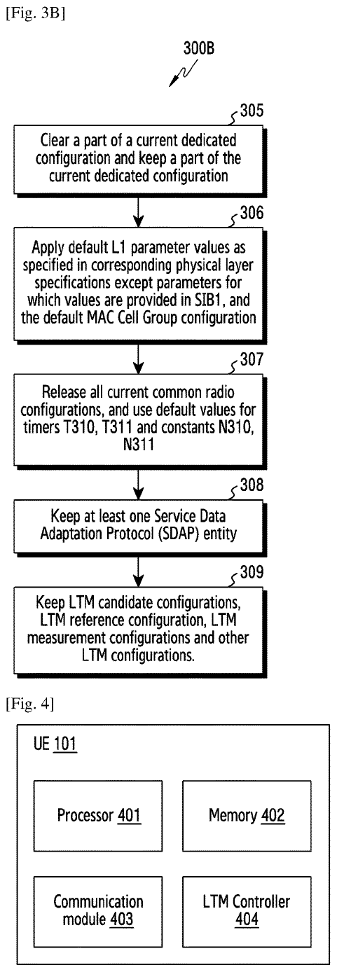

FIG. 3A is a flowchart depicting the process of performing Lower-layer Triggered Mobility (LTM) in New Radio (NR). In step 301, the UE 101 receives a LTM reference configuration in Radio Resource Control (RRC) signalling from the gNB 102. The gNB 102 can provide the LTM reference configuration using a parameterized type SetupRelease as defined in NR RRC. The UE 101 can further add, modify, or release the reference configuration based on the received parameterized type SetupRelease. In step 302, the UE 101 checks if a flag has been received, wherein the flag indicates to the UE 101 to apply the complete configuration for LTM (also referred to as full configuration for LTM interchangeably) in LTM candidate cell configuration. If the flag has been received, in step 303, the UE 101 performs a full configuration for LTM by applying the received LTM candidate cell configuration, on LTM trigger. When performing the full configuration for LTM, the UE 101 clears a part of a current dedicated configuration and keeps a part of the current dedicated configuration. The part of the current dedicated configuration that is kept can be at least one of a logged measurement configuration; Master Cell Group (MCG) Cell Radio Network Temporary Identifier (C-RNTI); at least one Access Stratum (AS) security configuration associated with at least one of a master key, and a secondary key. The UE 101 further applies default L1 parameter values as specified in corresponding physical layer specifications except parameters for which values are provided in SIB1, and the default MAC Cell Group configuration. The UE 101 releases all current common radio configurations, and uses default values for timers T310, T311 and constants N310, N311. While performing the full configuration for LTM, the UE 101 keeps at least one Service Data Adaptation Protocol (SDAP) entity. If the flag has not been received, in step 304, the UE 101 applies the LTM candidate cell configuration as a delta configuration of the reference configuration, on LTM trigger. The UE 101 further stores the received LTM configuration, and retains the stored LTM configuration. The stored LTM configuration comprises of LTM candidate cell configuration, LTM reference configuration and the L1 measurement configuration for LTM, when the UE is performing the full configuration for LTM. The various actions in method 300A may be performed in the order presented, in a different order or simultaneously. Further, in some embodiments, some actions listed in FIG. 3A may be omitted.

FIG. 3B is a flowchart depicting the process of performing a full configuration. When performing the full configuration for LTM, in step 305, the UE 101 clears a part of a current dedicated configuration and keeps a part of the current dedicated configuration. The part of the current dedicated configuration that is kept can be at least one of a logged measurement configuration; Master Cell Group (MCG) Cell Radio Network Temporary Identifier (C-RNTI); at least one Access Stratum (AS) security configuration associated with at least one of a master key, and a secondary key. In step 306, the UE 101 further applies default L1 parameter values as specified in corresponding physical layer specifications except parameters for which values are provided in SIB1, and the default MAC Cell Group configuration. In step 307, the UE 101 releases all current common radio configurations, and uses default values for timers T310, T311 and constants N310, N311. Further, in step 308, the UE 101 keeps at least one Service Data Adaptation Protocol (SDAP) entity. In step 309, the UE 101 keeps LTM candidate configurations, LTM reference configuration, LTM measurement configurations and other LTM configurations. The various actions in method 300B may be performed in the order presented, in a different order or simultaneously. Further, in some embodiments, some actions listed in FIG. 3B may be omitted.

FIG. 4 depicts a UE configured to perform Lower-layer Triggered Mobility (LTM) in New Radio (NR). The UE 101, as depicted, comprises a processor 401, a memory 402, a communication module 403, and a LTM controller 404. The processor 401 can be coupled with the memory 402, the communication module 403, and the LTM controller 404.

The LTM controller 404 can be implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The LTM controller 404 can receive the LTM reference configuration in Radio Resource Control (RRC) signalling from the gNB 102. The gNB 102 can provide the LTM reference configuration using a parameterized type SetupRelease as defined in NR RRC. The LTM controller 404 can further add, modify, or release the reference configuration based on the received parameterized type SetupRelease. The LTM controller 404 can check if a flag has been received, wherein the flag indicates to the LTM controller 404 to apply the complete configuration for LTM in LTM candidate cell configuration. If the flag has been received, the LTM controller 404 can perform a full configuration for LTM by applying the received LTM candidate cell configuration, on LTM trigger. When performing the full configuration for LTM, the LTM controller 404 can clear a part of a current dedicated configuration and keeping a part of the current dedicated configuration. The part of the current dedicated configuration that is kept can be at least one of a logged measurement configuration; Master Cell Group (MCG) Cell Radio Network Temporary Identifier (C-RNTI); at least one Access Stratum (AS) security configuration associated with at least one of a master key, and a secondary key. The LTM controller 404 can further apply default L1 parameter values as specified in corresponding physical layer specifications except parameters for which values are provided in SIB1, and the default MAC Cell Group configuration. The LTM controller 404 can release all current common radio configurations, and use default values for timers T310, T311 and constants N310, N311. While performing the full configuration for LTM, the LTM controller 404 can keep at least one Service Data Adaptation Protocol (SDAP) entity. If the flag has not been received, the LTM controller 404 can apply the LTM candidate cell configuration as a delta configuration of the reference configuration, on LTM trigger. The LTM controller 404 can further store the received LTM configuration, and retains the stored LTM configuration. The stored LTM configuration comprises of LTM candidate cell configuration, LTM reference configuration and the L1 measurement configuration for LTM, when the UE is performing the full configuration for LTM.

The processor 401 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 401 may include multiple cores and is configured to execute the instructions stored in the memory 402.

Further, the processor 401 is configured to execute instructions stored in the memory 402 and to perform various processes. The communicator 403 can be configured for communicating internally between internal hardware components and with external devices via one or more networks. The memory 402 can also store instructions to be executed by the processor 401. The memory 402 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 402 may, in some examples, be considered a non-transitory storage medium. The term “non-transitory” may indicate that the storage medium is not embodied in a carrier wave or a propagated signal. However, the term “non-transitory” should not be interpreted that the memory 402 is non-movable. In certain examples, a non-transitory storage medium may store data that can, over time, change (e.g., in Random Access Memory (RAM) or cache).

Although the FIG. 4 shows various hardware components of the UE 101 but it is to be understood that other embodiments are not limited thereon. In other embodiments, the UE 101 may include less or more number of components. Further, the labels or names of the components are used only for illustrative purpose and does not limit the scope of the invention. One or more components can be combined together to perform same or substantially similar function in the UE 101.

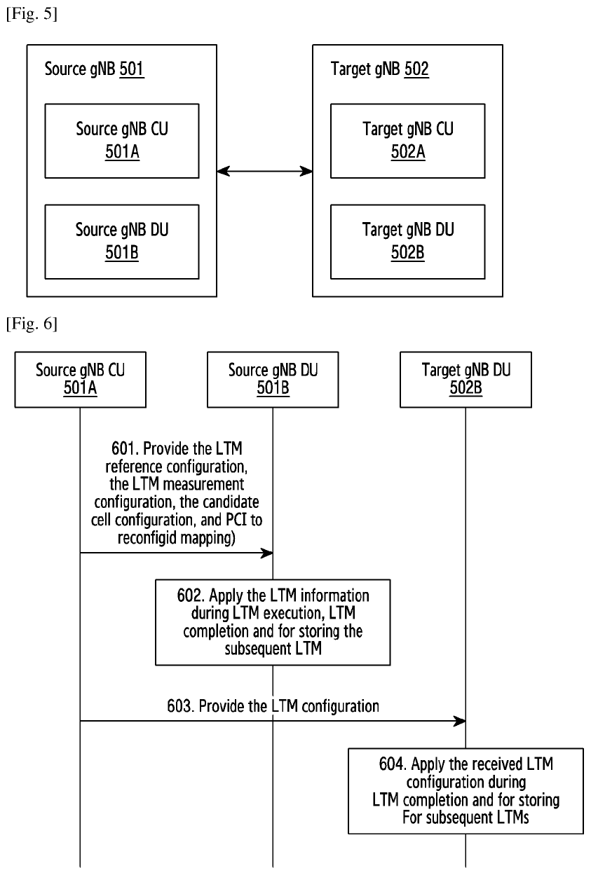

FIG. 5 depicts a wireless communication network comprising a source gNB, and a target gNB. Consider that the gNBs 501, 502 are implemented using a split architecture; i.e., the architecture of the gNBs 501, 502 are implemented across one or more Centralized Units (CU) 501A, 502A and Distributed Units (DU) 501B, 502B. The source gNB CU 501A can communicate the LTM reference configuration to the source gNB DU 501B (wherein the source gNB DU 501B has the source candidate cell) or the target gNB DU 502B (wherein the target gNB DU 502B has the target candidate cells). In various embodiments herein, the source gNB CU 501A can provide the reference configuration in the CG-Config message (RRC InterNode message). In various embodiments, the source gNB CU 501A can communicate only a part of LTM reference configuration (i.e., a part of the LTM reference configuration to be send to the UE) in the CG-Config. The part of LTM reference configuration communicated to the gNB DU 501B/502B can include the reference cell group configuration to be used for LTM.

An example sequence including one or more of the LTM reference configuration is given below:

```
CG-Config-IEs ::= SEQUENCE {
<other IEs and different levels of other IEs>
}
CG-Config-v1700-IEs ::= SEQUENCE {
  candidateCellInfoListCPC-r17 CandidateCellInfoListCPC-r17 OPTIONAL,
  twoPHRModeSCG-r17 ENUMERATED {enabled} OPTIONAL,
  nonCriticalExtension CG-Config-v1800-IEs OPTIONAL
}
CG-Config-v1800-IEs ::= SEQUENCE {
  candLTM-Refconfig LTMRefConfigType ,
OPTIONAL,
}
or
CG-Config-v1800-IEs ::= SEQUENCE {
  candLTM-Refconfig CellGroupConfig,
OPTIONAL,
}
```

In various embodiments, the gNB CU 501A can send the LTM configuration including the LTM measurement configuration to the gNB DU 501B/502B. The LTM measurement configuration includes L1 measurement configuration for LTM, including the measurement objects for LTM measurements (such as the frequencies to be measured, the cells to be measured for LTM measurements, measurement identifiers for LTM measurements, measurement gap configurations for LTM measurements, reporting configuration including the measurement filters/thresholds/offsets etc. for LTM measurements, and so on). In various embodiments herein, the gNB CU 501A can send the above information to the gNB DU 501B/502B in an Inter node RRC message, CG-Config or in a F1AP message (such as, but not limited to, a F1AP UEContext Setup Request, or a F1AP UEContext Modification Request).

In various embodiments, the gNB CU sends the LTM configuration including the candidate cell configuration for neighbor cells to the gNB DU. In various embodiments, the gNB CU sends the LTM configuration including the mapping of candLTM-ReconfigId to the PCI of the candidate neighbor cell to the gNB DU. In various embodiments, the gNB sends the above information to the gNB DU in the Inter node RRC message, CG-Config or in a F1AP message (such as, but not limited to, a F1AP UEContext Setup Request, or a F1AP UEContext Modification Request).

The gNB DU 501B/502B can generate a delta configuration based on the received LTMRefConfig. In various embodiments, if the gNB CU 501A does not provide the reference configuration to the gNB DU 501B/502B, the gNB DU 501B/502B can generate a full configuration for LTM. In various embodiments, the gNB CU 501A can provide the gNB DU 501B/502B with information to identify the cell (such as, but not limited to, a cell identifier, PCI, and so on). The gNB CU 501 can inform the gNB DU 501B/502B to perform LTM full configuration instead of the reference configuration.

In various embodiments herein, the gNB CU 501A can inform the gNB DU 501B/502B to release the reference configuration. In various embodiments herein, the gNB DU 501B/502B can generate a complete LTM configuration and inform the gNB CU 501A when the reference configuration is released. In various embodiments herein, the gNB CU 501A can inform the gNB DU 501B/502B to release the reference configuration in a F1AP message (such as, but not limited to, F1AP UE Context Modification Request), and the gNB DU 501B/502B can include complete LTM configuration in the F1AP UE Context Modification Response. In various embodiments herein, if the gNB DU 501B/502B receives the instruction to release the reference configuration and there is no reference configuration received, the gNB 501 does not consider this as an error and sends F1AP UE Context Modification Response, and also may include complete LTM configuration in the F1AP UE Context Modification Response. Alternatively, the gNB DU 501 may raise an error and send a F1AP UE Context Modification Failure.

FIG. 6 depicts an example process of performing CU-DU interaction for Lower Layer Triggered Mobility (LTM). In step 601, the gNB CU 501A provides the LTM reference configuration, the LTM measurement configuration, the candidate cell configuration, and PCI to reconfigid mapping to the source gNB DU 501B (wherein the source gNB DU 501B has the source candidate cell). In step 602, the source gNB DU 501B applies the LTM information during LTM execution, LTM completion and for storing the subsequent LTM in a suitable location. In step 603, the source gNB CU 501A provides the LTM configuration to the target gNB DU 502B. In step 604, the target gNB DU 501B applies the received LTM configuration during LTM completion and for storing for subsequent LTMs in a suitable location.

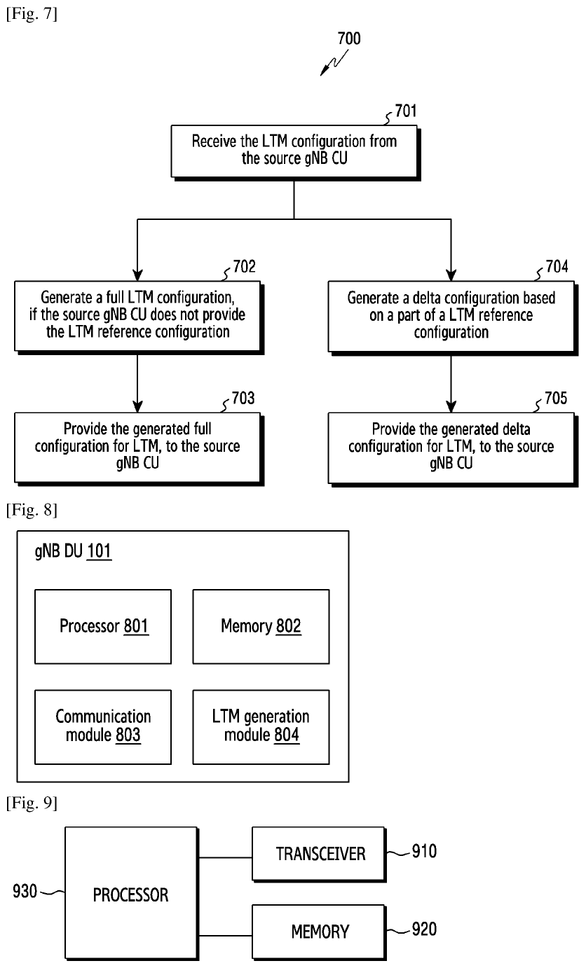

FIG. 7 is a flowchart depicting the process of handling a configuration in New Radio (NR). In step 701, the gNB DU 501B/502B receives the LTM configuration from the source gNB CU 501A. The LTM configuration can include at least one of LTM reference configuration, LTM candidate cell configuration and LTM measurement configuration. In step 702, the gNB DU 501B/502B generates a full Lower-layer Triggered Mobility (LTM) configuration, if the source gNB CU 501A does not provide the LTM reference configuration to the gNB DU 501B/502B. In step 703, the gNB DU 501B/502B provides the full configuration for LTM to the source gNB CU 501A. In step 704, the gNB DU 501B/502B generates a delta configuration based on a LTM reference configuration. The received LTM reference configuration received from the source gNB CU 501A includes a part of LTM reference configuration (to be) send to the UE 101, i.e. reference cell group configuration to be used for generating the delta configuration. The received LTM reference configuration that is used by the gNB DU 501B/502B is received from the source gNB CU 501A. In step 705, the gNB DU 501B/502B provides the delta configuration for LTM to the source gNB CU 501A. The source gNB CU 501A may include the delta configuration for LTM or full configuration for LTM in the LTM candidate configuration send to the UE 101. The various actions in method 700 may be performed in the order presented, in a different order or simultaneously. Further, in some embodiments, some actions listed in FIG. 7 may be omitted.

FIG. 8 depicts a gNB DU (which can be either the source gNB DU 501B, or the target gNB DU 502B) configured to handle a configuration in New Radio (NR). The gNB DU 501B/502B, as depicted, comprises a processor 801, a memory 802, a communication module 803, and a LTM generation module 804. The processor 801 can be coupled with the memory 802, the communication module 803, and the LTM generation module 804.

The LTM generation module 804 can be implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The LTM generation module 804 can receive the LTM configuration from the source gNB CU 501A. The LTM configuration can include at least one of LTM reference configuration, LTM candidate cell configuration and LTM measurement configuration. The LTM generation module 804 can generate a full Lower-layer Triggered Mobility (LTM) configuration, if the source gNB CU 501A does not provide the LTM reference configuration to the gNB DU 501B/502B. The LTM generation module 804 can generate a delta configuration based on a LTM reference configuration. The received LTM reference configuration received from the source gNB CU 501A includes the part of LTM reference configuration (to be) send to the UE 101 by the gNB CU 501A. The part of the LTM reference configuration includes the reference cell group configuration to be used for generating the delta configuration. The received LTM reference configuration that is used by the LTM generation module 804 can be received from the source gNB CU 501A. The LTM generation module 804 can provide at least one of the full configuration for LTM, and the delta configuration for LTM to the source gNB CU 501A.

The processor 801 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 801 may include multiple cores and is configured to execute the instructions stored in the memory 802.

Further, the processor 801 is configured to execute instructions stored in the memory 802 and to perform various processes. The communicator 803 can be configured for communicating internally between internal hardware components and with external devices via one or more networks. The memory 802 can also store instructions to be executed by the processor 801. The memory 802 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 802 may, in some examples, be considered a non-transitory storage medium. The term “non-transitory” may indicate that the storage medium is not embodied in a carrier wave or a propagated signal. However, the term “non-transitory” should not be interpreted that the memory 802 is non-movable. In certain examples, a non-transitory storage medium may store data that can, over time, change (e.g., in Random Access Memory (RAM) or cache).

Although the FIG. 8 shows various hardware components of the gNB DU 501B/502B, but it is to be understood that other embodiments are not limited thereon. In other embodiments, the gNB DU 501B/502B may include less or more number of components. Further, the labels or names of the components are used only for illustrative purpose and does not limit the scope of the invention. One or more components can be combined together to perform same or substantially similar function in the gNB DU 501B/502B.

FIG. 9 illustrates a structure of a UE according to an embodiment of the disclosure.

As shown in FIG. 9, the UE according to an embodiment may include a transceiver 910, a memory 920, and a processor 930. The transceiver 910, the memory 920, and the processor 930 of the UE may operate according to a communication method of the UE described above. However, the components of the UE are not limited thereto. For example, the UE may include more or fewer components than those described above. In addition, the processor 930, the transceiver 910, and the memory 920 may be implemented as a single chip. Also, the processor 930 may include at least one processor. Furthermore, the UE of FIG. 9 corresponds to the UE of the FIG. 4.

The transceiver 910 collectively refers to a UE receiver and a UE transmitter, and may transmit/receive a signal to/from a base station or a network entity. The signal transmitted or received to or from the base station or a network entity may include control information and data. The transceiver 910 may include a RF transmitter for upconverting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the UE. Also, the memory 920 may store control information or data included in a signal obtained by the UE. The memory 920 may be a storage medium, such as read-only memory (ROM), random access memory (RAM), a hard disk, a CD-ROM, and a DVD, or a combination of storage media.

The processor 930 may control a series of processes such that the UE operates as described above. For example, the transceiver 910 may receive a data signal including a control signal transmitted by the base station or the network entity, and the processor 930 may determine a result of receiving the control signal and the data signal transmitted by the base station or the network entity.

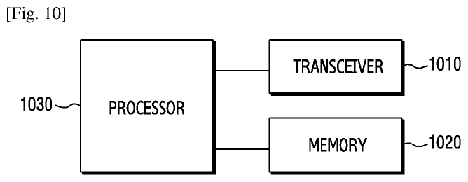

FIG. 10 illustrates a structure of a base station according to an embodiment of the disclosure.

As shown in FIG. 10, the base station according to an embodiment may include a transceiver 1010, a memory 1020, and a processor 1030. The transceiver 1010, the memory 1020, and the processor 1030 of the base station may operate according to a communication method of the base station described above. However, the components of the base station are not limited thereto. For example, the base station may include more or fewer components than those described above. In addition, the processor 1030, the transceiver 1010, and the memory 1020 may be implemented as a single chip.

Also, the processor 1030 may include at least one processor. Furthermore, the base station of FIG. 10 corresponds to the base station of the FIG. 8.

The transceiver 1010 collectively refers to a base station receiver and a base station transmitter, and may transmit/receive a signal to/from a terminal (UE) or a network entity. The signal transmitted or received to or from the terminal or a network entity may include control information and data. The transceiver 1010 may include a RF transmitter for up-converting and amplifying a frequency of a transmitted signal, and a RF receiver for amplifying low-noise and down-converting a frequency of a received signal. However, this is only an example of the transceiver 1010 and components of the transceiver 1010 are not limited to the RF transmitter and the RF receiver.

Also, the transceiver 1010 may receive and output, to the processor 1030, a signal through a wireless channel, and transmit a signal output from the processor 1030 through the wireless channel.

The memory 1020 may store a program and data required for operations of the base station. Also, the memory 1020 may store control information or data included in a signal obtained by the base station. The memory 1020 may be a storage medium, such as read-only memory (ROM), random access memory (RAM), a hard disk, a CDROM, and a DVD, or a combination of storage media.

The processor 1030 may control a series of processes such that the base station operates as described above. For example, the transceiver 1010 may receive a data signal including a control signal transmitted by the terminal, and the processor 1030 may determine a result of receiving the control signal and the data signal transmitted by the terminal.

The processor disclosed herein may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In various embodiments, A method (300A) for performing Lower-layer Triggered Mobility (LTM) in New Radio (NR), the method comprising: receiving (301), by a User Equipment (UE) (101), from a gNodeB (gNB) (102) at least one of: a flag indicating to apply complete configuration for LTM in LTM candidate cell configuration and a LTM reference configuration in Radio Resource Control (RRC) signalling; performing (303), by the UE (101), a full configuration for LTM by applying the received LTM candidate cell configuration, if the flag has been received, on LTM trigger; and applying (304), by the UE (101), the LTM candidate cell configuration as a delta configuration of the reference configuration, if the flag has not been received, on LTM trigger.

In various embodiments, the LTM reference configuration is provided using a parameterized type SetupRelease as defined in NR RRC, wherein the method further comprises the UE adding, modifying, or releasing the reference configuration based on the received parameterized type SetupRelease.

In various embodiments, wherein performing the full configuration for LTM comprises: clearing (305), by the UE (101), a part of a current dedicated configuration and keeping a part of the current dedicated configuration, wherein the part of the current dedicated configuration that is kept is at least one of a logged measurement configuration; Master Cell Group (MCG) Cell Radio Network Temporary Identifier (C-RNTI); at least one Access Stratum (AS) security configuration associated with at least one of a master key, and a secondary key; applying (306), by the UE (101), default L1 parameter values as specified in corresponding physical layer specifications except parameters for which values are provided in SIB1; applying (306), by the UE (101), default MAC Cell Group configuration; releasing (307), by the UE (101), all current common radio configurations; and using (307), by the UE (101), default values for timers T310, T311 and constants N310, N311.

In various embodiments, wherein the method further comprises: storing, by the UE (101), the received LTM configuration; and retaining (309), by the UE (101), the stored LTM configuration, wherein the stored LTM configuration comprises of LTM candidate cell configuration, LTM reference configuration and the L1 measurement configuration for LTM, when the UE is performing the full configuration for LTM.

In various embodiments, wherein the method comprises keeping (308), by the UE (101), at least one Service Data Adaptation Protocol (SDAP) entity while performing the full configuration for LTM.

In various embodiments, A method (700) for handling a configuration in New Radio (NR), the method comprising: receiving (701), by a gNodeB (gNB) Distributed Unit (DU) (501B/502B), LTM configuration from a gNB Centralized Unit (CU) (501A), wherein the LTM configuration includes at least one of LTM reference configuration, LTM candidate cell configuration and LTM measurement configuration; generating (702), by the gNodeB (gNB) DU (501B/502B), a full Lower-layer Triggered Mobility (LTM) configuration, if the gNB CU (501A) does not provide the LTM reference configuration to the gNB DU (501B/502B); generating (704), by the gNB DU (501B/502B), a delta configuration based on a LTM reference configuration, wherein the received LTM reference configuration is received from the gNB CU (501A); and providing (703, 705), by the gNB DU (501B/502B), at least one of the full configuration for LTM, and the delta configuration for LTM to the gNB CU (501A).

In various embodiments, wherein the received LTM reference configuration received from the gNB CU (501A) includes reference cell group configuration to be used for generating the delta configuration.

In various embodiments, wherein the gNB DU (501B/502B) is at least one of a source gNB DU (501B); and a target gNB DU (502B).

In various embodiments, A User Equipment (UE) (101) comprising: a processor; a memory; and a Lower-layer Triggered Mobility (LTM) controller, coupled with the processor and the memory, configured to: receive from a gNodeB (gNB), at least one of: a flag indicating to apply complete configuration for LTM in LTM candidate cell configuration and a LTM reference configuration in Radio Resource Control (RRC) signalling; perform a full configuration for LTM by applying the received LTM candidate cell configuration, if the flag has been received, on LTM trigger; and apply the LTM candidate cell configuration as a delta configuration of the reference configuration, if the flag has not been received, on LTM trigger.

In various embodiments, wherein the LTM reference configuration is provided using a parameterized type SetupRelease as defined in NR RRC, wherein the LTM controller is further configured to add, modify, or release the reference configuration based on the received parameterized type SetupRelease.

In various embodiments, wherein the UE (101) is further configured to perform the full configuration for LTM by: clearing a part of a current dedicated configuration and keeping a part of the current configuration, wherein the part of the current configuration that is kept is at least one of a logged measurement configuration; Master Cell Group (MCG) Cell Radio Network Temporary Identifier (C-RNTI); at least one Access Stratum (AS) security configuration associated with at least one of a master key, and a secondary key; applying default L1 parameter values as specified in corresponding physical layer specifications except parameters for which values are provided in SIB1; applying default MAC Cell Group configuration; releasing all current common radio configurations; and using default values for timers T310, T311 and constants N310, N311.

In various embodiments, wherein the LTM controller is further configured to: store the received LTM configuration; and retain the stored LTM configuration, wherein the stored LTM configuration comprises of LTM candidate cell configuration, LTM reference configuration and the L1 measurement configuration for LTM, when the UE is performing the full configuration for LTM.

In various embodiments, wherein the LTM controller is further configured to keep at least one Service Data Adaptation Protocol (SDAP) entity while performing the full configuration for LTM.

In various embodiments, A gNodeB (gNB) Distributed Unit (DU) (501B/502B) configured to: receive LTM configuration from a gNB Centralized Unit (CU) (501A), wherein the LTM configuration includes at least one of LTM reference configuration, LTM candidate cell configuration and LTM measurement configuration; generate a full Lower-layer Triggered Mobility (LTM) configuration, if the gNB CU (501A) does not provide the LTM reference configuration to the gNB DU (501B/502B); generate a delta configuration based on a part of a LTM reference configuration, wherein the part of the received LTM reference configuration is received from the gNB CU (501A); and provide at least one of the full configuration for LTM, and the delta configuration for LTM to the gNB CU (501A).

The embodiments disclosed herein can be implemented through at least one software program running on at least one hardware device and performing network management functions to control the network elements. The elements include blocks which can be at least one of a hardware device, or a combination of hardware device(s) and software module(s).

The embodiment disclosed herein describes methods and systems for performing Lower-layer Triggered Mobility (LTM) in New Radio (NR). Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

1-15. (canceled)

16. A method performed by a user equipment (UE) in a wireless communication system, the method comprising:
receiving, from a base station, a radio resource control (RRC) reconfiguration message including a lower layer triggered mobility (LTM) candidate configuration; and
in case that information indicating that the LTM candidate configuration is a complete configuration is not received, applying the LTM candidate configuration by considering an LTM reference configuration included in the RRC reconfiguration message.

17. The method of claim 16, further comprising:
in case that the information is received, applying the LTM candidate configuration as a full configuration.

18. The method of claim 16, further comprising:
releasing a current configuration except for at least one configuration for LTM cell switch, and
wherein the at least one configuration includes at least one of:
a master cell group (MCG) cell radio network temporary identifier (C-RNTI),
an access stratum (AS) security configuration,
a radio bearer configuration,
a logged measurement configuration, or
a configuration associated with a SDAP (service data adaptation protocol) entity.

19. The method of claim 16, further comprising:
applying at least one of a default L1 (layer 1) parameter value, a default MAC (medium access control) cell group configuration, or a default value for a timer.

20. A user equipment (UE) comprising:
at least one transceiver;
at least one processor communicatively coupled to the at least one transceiver; and
at least one memory, communicatively coupled to the at least one processor, storing instructions executable by the at least one processor individually or in any combination to cause the UE to:
receive, from a base station, a radio resource control (RRC) reconfiguration message including a lower layer triggered mobility (LTM) candidate configuration; and
in case that information indicating that the LTM candidate configuration is a complete configuration is not received, apply the LTM candidate configuration by considering an LTM reference configuration included in the RRC reconfiguration message.

21. The UE of claim 20, wherein the instructions further cause the UE to:
in case that the information is received, apply the LTM candidate configuration as a full configuration.

22. The UE of claim 20, wherein the instructions further cause the UE to:
release a current configuration except for at least one configuration for LTM cell switch, and
wherein the at least one configuration includes at least one of:
a master cell group (MCG) cell radio network temporary identifier (C-RNTI),
an access stratum (AS) security configuration,
a radio bearer configuration,
a logged measurement configuration, or
a configuration associated with a SDAP (service data adaptation protocol) entity.

23. The UE of claim 20, wherein the instructions further cause the UE to:
apply at least one of a default L1 (layer 1) parameter value, a default MAC (medium access control) cell group configuration, or a default value for a timer.

24. A method performed by a base station in a wireless communication system, the method comprising:
transmitting, to a user equipment (UE), a radio resource control (RRC) reconfiguration message including a lower layer triggered mobility (LTM) candidate configuration,
wherein, in case that information indicating that the LTM candidate configuration is a complete configuration is not transmitted, the LTM candidate configuration is applied based on an LTM reference configuration included in the RRC reconfiguration message.

25. The method of claim 24, wherein, in case that the information is transmitted, the LTM candidate configuration is applied as a full configuration.

26. The method of claim 24,
wherein the LTM candidate configuration is applied based on releasing a current configuration except for at least one configuration for LTM cell switch, and
wherein the at least one configuration includes at least one of:
a master cell group (MCG) cell radio network temporary identifier (C-RNTI),
an access stratum (AS) security configuration,
a radio bearer configuration,
a logged measurement configuration, or
a configuration associated with a SDAP (service data adaptation protocol) entity.

27. The method of claim 26, wherein at least one of a default L1 (layer 1) parameter value, a default MAC (medium access control) cell group configuration, or a default value for a timer is applied for the LTM cell switch.

28. A base station comprising:
at least one transceiver;
at least one processor communicatively coupled to the at least one transceiver; and
at least one memory, communicatively coupled to the at least one processor, storing instructions executable by the at least one processor individually or in any combination to cause the base station to transmit, to a user equipment (UE), a radio resource control (RRC) reconfiguration message including a lower layer triggered mobility (LTM) candidate configuration,
wherein, in case that information indicating that the LTM candidate configuration is a complete configuration is not transmitted, the LTM candidate configuration is applied based on an LTM reference configuration included in the RRC reconfiguration message.

29. The base station of claim 28, wherein, in case that the information is transmitted, the LTM candidate configuration is applied as a full configuration.

30. The base station of claim 28,
wherein the LTM candidate configuration is applied based on releasing a current configuration except for at least one configuration for LTM cell switch,
wherein the at least one configuration includes at least one of:
a master cell group (MCG) cell radio network temporary identifier (C-RNTI),
an access stratum (AS) security configuration,
a radio bearer configuration,
a logged measurement configuration, or
a configuration associated with a SDAP (service data adaptation protocol) entity, and
wherein at least one of a default L1 (layer 1) parameter value, a default MAC (medium access control) cell group configuration, or a default value for a timer is applied for the LTM cell switch.
